(19) United States
(12) Patent Application Publication
(10) Pub. No.: US 2012/0066134 A1
(43) Pub. Date: Mar. 15, 2012

(54) COMMUNICATION SYSTEM, COMMUNICATION APPARATUS, AND COMMUNICATION METHOD

(75) Inventor: Takanori WASHIRO, Kanagawa (JP)

(73) Assignee: SONY CORPORATION, Tokyo (JP)

(21) Appl. No.: 13/197,041

(22) Filed: Aug. 3, 2011

(30) Foreign Application Priority Data
Sep. 13, 2010 (JP) 2010-204039

(51) Int. Cl. G06F 21/00

(52) U.S. Cl. 705/59; 726/30

(57) ABSTRACT

A communication system includes: a first communication apparatus connected to a license management server which manages a license key for content via a network; a second communication apparatus which performs a first non-contact communication with the first communication apparatus; and a third communication apparatus which performs a second non-contact communication with the first communication apparatus, wherein the first communication apparatus performs receiving of content, whose copyright is managed, from the second communication apparatus by the first non-contact communication and transferring the content to the third communication apparatus by the second non-contact communication, and obtaining a license key for the content from the license management server via the network and transferring the license key to the third communication apparatus by the second non-contact communication.

### BACKGROUND

The present disclosure relates to a communication system, a communication apparatus, and a communication method for non-contact communication, and particularly to a communication system, a communication apparatus, and a communication method by which content whose copyright is managed is exchanged by non-contact communication.

Non-contact communication is a wireless technology by which data transmission is performed within a transmission distance from 0 to several ten cm, and there are advantages in that there is not much influence of interference due to a small reflective wave from a reflection object existing in the circumference and in that it is not necessary to consider prevention of hacking and security of confidentiality on the transmission path. Examples of the non-contact communication method include an electrostatic coupling type, an electromagnetic induction type, a radio frequency communication type, and the like.

Close proximity wireless transfer “TransferJet (registered trademark)” (see Japanese Patent No. 4345851, and www.transferjet.org/en/index.html (as of Sep. 1, 2010), for example) using a faint UWB (Ultra Wide Band) signal is able to be exemplified as a non-contact communication technology which can be applied to high-speed communication. This close proximity wireless transfer technology (TransferJet) is essentially a scheme in which a signal is transmitted using a coupling action of an induction field, the communication apparatus thereof includes a communication circuit unit which performs processing of a high-frequency signal, a coupling electrode arranged so as to be distant from the ground with a height to some extent, and a resonance unit which effectively supplies the high-frequency signal to the coupling electrode. A component including the coupling electrode or the coupling electrode and the resonance unit is also referred to as a “high-frequency coupler” in this specification.

The non-contact communication has been mounted on a mobile terminal or the like and has been widely used as a medium for valuable information such as authentication information, electronic money, and the like. Recently, applications to large-volume data transmission such as downloading and streaming of content files including video images, music, and the like has been contrived as a more advanced application based on the non-contact communication along with the enhancement in communication speed.

It is convenient to exchange various data items between mobile terminals with the use of the non-contact communication. However, copyrights of many digital content items are protected by encryption or the like, and the content is not available on a mobile terminal as a transfer destination by merely moving or copying the data thereof. That is, the content is not reproduced as long as the mobile terminal which has received the content separately obtains license key data from a license management server via a broadband network such as a cellular network, or the Internet after the exchange of the content, whose copyright is managed in a digital manner, by the non-contact communication between the mobile terminals, which deteriorates practical utility.

That is, fee-charged content is not reproduced on a mobile terminal since the license key is not available for the mobile terminal without a function of connecting to the network even though the mobile terminal can receive the data of the content itself from another neighboring mobile terminal by non-contact communication.

In addition, a utilization form in which a user of a mobile terminal mounting a non-contact communication function recommends fee-charged content to his/her friend who is also a user of the mobile terminal can be considered. In such a case, there is no structure for managing who makes a recommendation to whom on the side of the system, and therefore, it is not possible to motivate a user to recommend content to his/her friends and acquaintances by giving the user who has recommended the content incentive such as points refund or the like.

### SUMMARY

It is desirable to provide an excellent communication system, a communication apparatus, and a communication method by which it is possible to preferably exchange content, whose copyright is managed, with the use of the non-contact communication.

According to an embodiment of the present disclosure, there is provided a communication system including: a first communication apparatus connected to a license management server which manages a license key for content via a network; a second communication apparatus which performs a first non-contact communication with the first communication apparatus; and a third communication apparatus which performs a second non-contact communication with the first communication apparatus, wherein the first communication apparatus performs receiving of content, whose copyright is managed, from the second communication apparatus by the first non-contact communication and transferring the content to the third communication apparatus by the second non-contact communication, and obtaining a license key for the content from the license management server via the network and transferring the license key to the third communication apparatus by the second non-contact communication.

However, “system” represents a logical group of a plurality of apparatuses (or functional modules which realize specific functions), and there is no restriction regarding whether or not each apparatus and functional module are in a single case body.

According to another embodiment of the present disclosure, there is provided a communication apparatus including: a first non-contact communication unit; a second non-contact communication unit; and a network communication unit, wherein content, whose copyright is managed, is received from a second communication apparatus by the first non-contact communication unit and transferred to a third communication apparatus by the second non-contact communication unit, and wherein a license key for the content is obtained from a license management server by the network communication unit and transferred to the third communication apparatus by the second non-contact communication unit.

According to the embodiment of the present disclosure, the communication apparatus is configured such that the license key for the content is obtained from the license management server and transferred to the third communication apparatus by the second non-contact communication unit after charging and authentication processing is performed on the third communication apparatus by the second non-contact communication unit.

According to the embodiment, points are paid to the second communication apparatus by the first non-contact communication unit in response to the charge on the third communication apparatus.

According to the embodiment of the present disclosure, the communication apparatus is configured such that at least one of the first and second non-contact communication units includes a communication circuit unit which performs processing on a high-frequency signal for transmitting data, a transmission path of a high-frequency signal, which is connected to the communication circuit unit, a ground, a coupling electrode which is supported so as to be distant from the ground by a height with which a wavelength of the high-frequency signal is ignorable, and a resonance unit which increases the current flowing into the coupling electrode via the transmission path, wherein a small dipole of a line segment connecting the center of the electric charge accumulated in the coupling electrode and the center of a mirror-image electric charge accumulated in the ground is formed, and the high-frequency signal is transmitted to a communication counterpart positioned in an opposing manner such that an angle θ with respect to the direction of the small dipole is about 0°.

According to still another embodiment of the present disclosure, there is provided a communication method of a communication apparatus including a first non-contact communication unit, a second non-contact communication unit, and a network communication unit, the method including: receiving content, whose copyright is managed, from a second communication apparatus by the first non-contact communication unit; transferring the content to a third communication apparatus by the second non-contact communication unit; obtaining a license key for the content from a license management server by the network communication unit; performing charging and authentication processing on the third communication apparatus by the second non-contact communication unit; and transferring the license key to the third communication apparatus by the second non-contact communication unit.

According to the present disclosure, it is possible to provide an excellent communication system, a communication apparatus, and a communication method by which it is possible to preferably exchange content, whose copyright is managed, with the use of the non-contact communication.

According to the embodiment of the present disclosure, it is possible to distribute content, whose copyright is managed, between users of mobile terminals (first and second communication apparatuses) via a kiosk terminal (first communication apparatus) without any sales situations and the network, and thereby to reduce the load of facilities and the network infrastructure.

In addition, according to the embodiment of the present disclosure, the second communication apparatus (mobile terminal) can potentially be a salesperson of content, and therefore, it is possible to give more opportunities for sales and promote the distribution of content. According to the embodiment of the present disclosure, a structure in which a user (second communication apparatus) receives points from the kiosk terminal (first communication apparatus) is provided, which motivates the users to recommend content to his/her friends and acquaintances and promote the distribution of content as a result. The communication apparatus according to the embodiment of the present disclosure is operated as a kiosk terminal, for example, and can relay the transfer of content between mobile terminals, access the license management server instead of the mobile terminal as the transfer destination of the content, obtain a license key, and transfer the license key to the mobile terminal.

According to the embodiment of the present disclosure, it is possible to realize ultrahigh speed data transmission of about 100 Mbps by applying close proximity wireless transfer “TransferJet (registered trademark)” using a faint UWB signal for non-contact communication. As a result, it is possible to transfer the content between the mobile terminals via the kiosk terminal in a short time.

Other purposes, features, and advantages of the present disclosure will be clarified by more detailed description based on the following embodiments and accompanying drawings of the present disclosure.

### BRIEF DESCRIPTION OF THE DRAWINGS

FIG. 1 is a diagram showing a configuration example of a communication system which exchanges content, whose copyright is managed, between mobile terminals via a kiosk terminal connected to the network by non-contact communication;

FIG. 2 is a diagram showing an operation sequence in the communication system shown in FIG. 1 when content, whose copyright is managed, is transferred between mobile terminals;

FIG. 3 is a diagram schematically showing a configuration example of a communication apparatus which can be operated as a kiosk terminal in the communication system shown in FIG. 1;

FIG. 4 is a diagram schematically showing a configuration example of a communication apparatus which can be operated as a mobile terminal in the communication system shown in FIG. 1;

FIG. 5 is a diagram schematically showing a configuration example of a high-frequency coupler used in a close proximity wireless transfer;

FIG. 6 is a diagram showing an electric field by a small dipole;

FIG. 7 is a flowchart showing a processing procedure executed by a first mobile terminal in the communication system shown in FIG. 1 when the operation sequence shown in FIG. 2 is performed;

FIG. 8 is a flowchart showing a processing procedure executed by a kiosk terminal in the communication system shown in FIG. 1 when the operation sequence shown in FIG. 2 is performed;

FIG. 9 is a flowchart showing a processing procedure executed by a second mobile terminal in the communication system shown in FIG. 1 when the operation sequence shown in FIG. 2 is performed;

FIG. 10 is a diagram schematically showing a configuration example of a communication system by which fee-charged content is purchased by a mobile terminal with the relay of a kiosk terminal connected to the network;

FIG. 11 is a diagram illustrating a flow when digital content is purchased (an example in the related art); and

FIG. 12 is a diagram illustrating a flow when content is exchanged between mobile terminals (an example in the related art).

### DETAILED DESCRIPTION OF EMBODIMENTS

Hereinafter, detailed description will be made of embodiments of the present disclosure with reference to the drawings.

If content can be distributed between users without a sales situation or the network, it is possible to reduce the load on facilities and network infrastructures. Since all users can potentially be salespersons of content, it is possible to give more opportunities for sales and promote the distribution of content. In addition, if there is a structure for giving an incentive such as points to a user who has sold content, it is possible to motivate a user to recommend content to his/her friends and acquaintances, and as a result, to promote the distribution of the content.

On the other hand, digital rights management (DRM) is made for many fee-charged content items in order to prevent unlimited usage by improper copying. A license key is necessary as well as data of content body part in order to reproduce the content whose copyright is managed. Generally, the copy of the license key is not available even though the data of the content body part can be exchanged between users. Therefore, it is necessary for a user who desires to reproduce the content to connect to the network at least once to obtain the license key from a license management server. In other words, it is not possible to reproduce fee-charged content without a function of connecting to the network.

FIG. 11 shows a flow when digital content is purchased (an example in the related art). A PC (Personal Computer) connected to the IP (Internet Protocol) network downloads content from a content provision server via the network and obtains a license key after charging and authenticating with the license management server. It is possible to reproduce the downloaded content on the PC with the use of the license key.

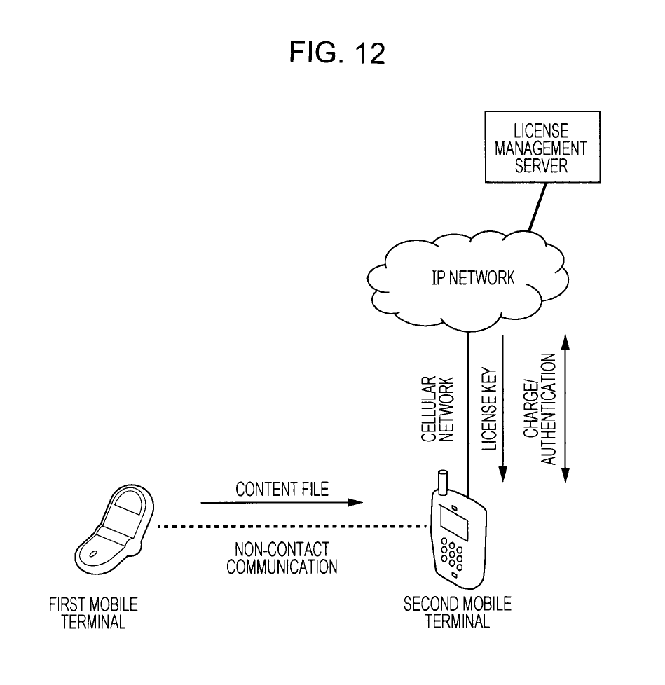

FIG. 12 shows a flow when content is exchanged between mobile terminals (an example in the related art). If both a first mobile terminal and a second mobile terminal mount non-contact communication functions, it is possible to move or copy a content file from the first mobile terminal to the second mobile terminal with the use of the non-contact communication. However, since it is not possible to transfer the license key from the first mobile terminal to the second mobile terminal in order to prevent the improper usage of the content, it is not possible to reproduce the content on the side of the second mobile terminal. It is necessary for the second mobile terminal to separately connect to the IP network via the cellular network or the like, perform charging and authentication processing with the license management server, and obtain the license key. It is easier for the second mobile terminal to connect to the network and download the content as compared with such procedures. No merit can be found in exchanging a content file between mobile terminals, and in other words, users do not become salespersons, and distribution of content is not promoted.

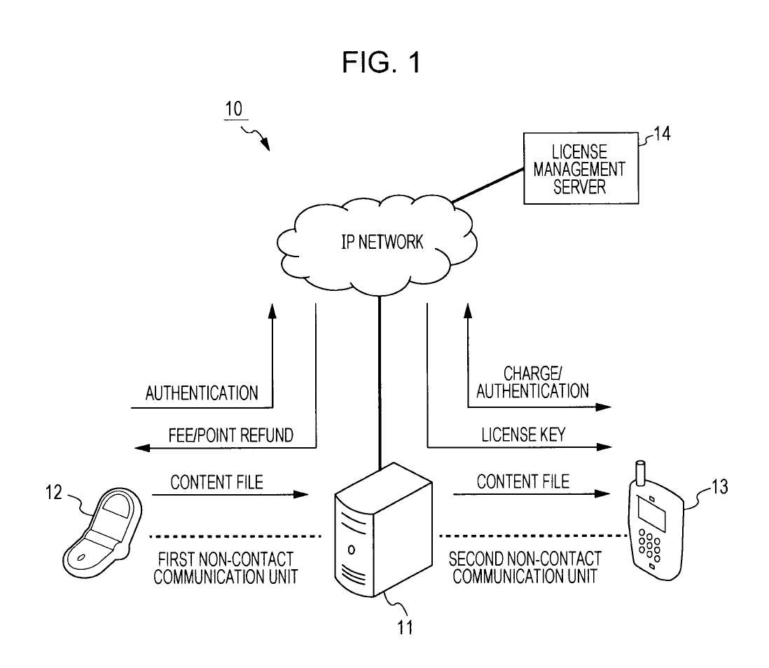

Thus, the present inventor proposes a communication system by which fee-charged content (that is, the content whose copyright is managed) between mobile terminals via a kiosk terminal connected to the network by non-contact communication. FIG. 1 schematically shows a configuration example of this communication system 10.

The communication system 10 shown in the drawing includes a kiosk terminal 11 including a network connection unit first and second non-contact communication units, a first mobile terminal 12 which is a transfer source of content, and a second mobile terminal 13 which is a transfer destination of the content. The kiosk terminal 11 can connect to the network and obtain a license key of content from a license management server 14. In addition, the first and second non-contact communication units can be independently operated without interfering with each other.

The first mobile terminal 12 and the second mobile terminal 13 respectively include non-contact communication units. Although it is not necessary for the non-contact communication unit of each mobile terminal to be based on the same communication scheme, it is assumed herein below that the first non-contact communication unit of the kiosk terminal 11 is based on the same communication scheme as that of the non-contact communication unit of the first mobile terminal 12 while the second non-contact communication unit of the kiosk terminal 11 is based on the same communication scheme as that of the non-contact communication unit of the second mobile terminal 13. In addition, the first non-contact communication unit and the second non-contact communication unit of the kiosk terminal 11 are installed with a sufficient distance so as not to interfere with each other. Accordingly, the kiosk terminal 11 can communicate with the first mobile terminal 12 and the second mobile terminal 13 at the same time without any interference.

Moreover, although the kiosk terminal 11 may be provided with original functions as a kiosk terminal such as on-line sales of tickets, printing of camera images, ATM services of banks, and the like, the description thereof will be omitted in this specification since other functions which are not related with the relay of content transfer are not the gist of the present disclosure.

First, the first mobile terminal 12 is held over the first non-contact communication unit of the kiosk terminal 11, and the second mobile terminal 13 is held over the second non-contact communication unit of the kiosk terminal 11, at the same time.

Then, a content file within the first mobile terminal 12 is moved (or copied) to the kiosk terminal 11 via the first non-contact communication unit, and the content file is then moved from the kiosk terminal 11 to the second mobile terminal 12 by the second non-contact communication unit.

The second mobile terminal 13 performs charging and authentication and obtains a license key via the kiosk terminal 11 with the use of the second non-contact communication unit (or another charge/authentication tool, such as “FeliCa (registered trademark)). Accordingly, it is possible to reproduce fee-charged content even if the second mobile terminal 13 itself separately connects to the license management server 14 on the network.

Since the first mobile terminal 12 provides the content file to the second mobile terminal 13, the user of the first mobile terminal 12 can potentially be a salesperson of the content. The kiosk terminal 11 pays commission charge or refunds points corresponding thereto in return to the first mobile terminal 12 with the use of the first non-contact communication unit (or another charge/authentication tool such as “FeliCa (registered trademark)” as the first mobile terminal 1 provides the content file. Such refund of points motivates a user of the mobile terminal to recommend the content to his/her friends and acquaintances. If more users recommend content, the more opportunities can be obtained for content sales, which results in promotion of content distribution.

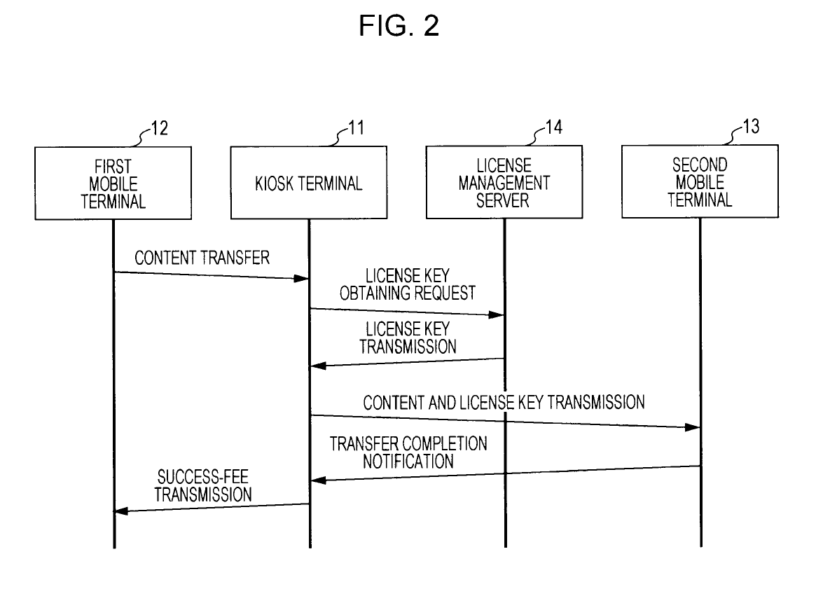

FIG. 2 shows an operation sequence in the communication system 10 shown in FIG. 1 when the content, whose copyright is managed, is transferred between the mobile terminals. It is assumed that the first mobile terminal 12 is held over the first non-contact communication unit of the kiosk terminal 11 while the second mobile terminal 13 is held over the second non-contact communication unit of the kiosk terminal 11.

First, the content file within the first mobile terminal 12 is transferred to the kiosk terminal 11 via the first non-contact communication unit.

The kiosk terminal 11 connects to the license management server 14 through the network and requests the obtaining of the license key for the content file received from the first mobile terminal 12. In response to this request, the license management server 14 transfers the requested license key to the kiosk terminal 11 via the network.

Subsequently, the kiosk terminal 11 transfers the content received from the first mobile terminal 12 and the license key to the second mobile terminal 13. Although detailed procedures are omitted in FIG. 2, the kiosk terminal 11 performs charging and authentication processing with the second mobile terminal 13 when the license key is transferred.

Then, the kiosk terminal 11 receives a transfer completion notification from the second mobile terminal 13, and then sends to the first mobile terminal 12 a completion bonus such as payment of commission charge or refund of points in return to the content sales.

Since the communication system 10 shown in FIG. 1 exchanges a content file with a large volume with the use of a local communication tool such as non-contact communication and exchanges only data with a small volume such as charging and authentication processing, obtaining of the license key, and the like with the use of the public network, it is possible to reduce the load on the network infrastructure.

When the content whose copyright is managed is exchanged between the first mobile terminal 12 and the second mobile terminal 13, the second mobile terminal 13 on the receiving side can obtain the license key at the same time as the content received from the kiosk terminal 11 via the kiosk terminal 11 and reproduce the content without separately connecting to the network.

In addition, since content is generally exchanged via the kiosk terminal 11, the kiosk terminal 11 can clearly grasp who has passed the content to whom (in other words, who is the user as the sales person of the content). Accordingly, the kiosk terminal 11 can provide a service such as a refund of commission charge or points corresponding thereto to the first mobile terminal 12 which has provided the content, as described above.

Since data with a large volume such as a content file is exchanged by local communication including only the first mobile terminal 12, the kiosk terminal 11, and the second mobile terminal 13 without any public network, and only information including a small amount of data such as a license key is exchanged through the network, it is possible to reduce the load on the network infrastructure.

If the kiosk terminal 11 is a small-sized mobile communication apparatus provided with a network connection function, it is possible to transfer fee-charged content downloaded in the first mobile terminal 12 to a car audio system or the like without any network connection function and reproduce the content by the car audio system or the like.

In addition, the number of copying is limited for many content items whose copyrights are managed. According to the communication system 10 shown in FIG. 1, it is possible to protect the copyright of content even if additional copying of content, which has already been copied the prescribed number of times, is allowed between the mobile terminals as long as the copying is performed via the kiosk terminal 11. It is also possible to configure the kiosk terminal 11 to charge for the copying to the mobile terminal as the copying destination when additional copying is made.

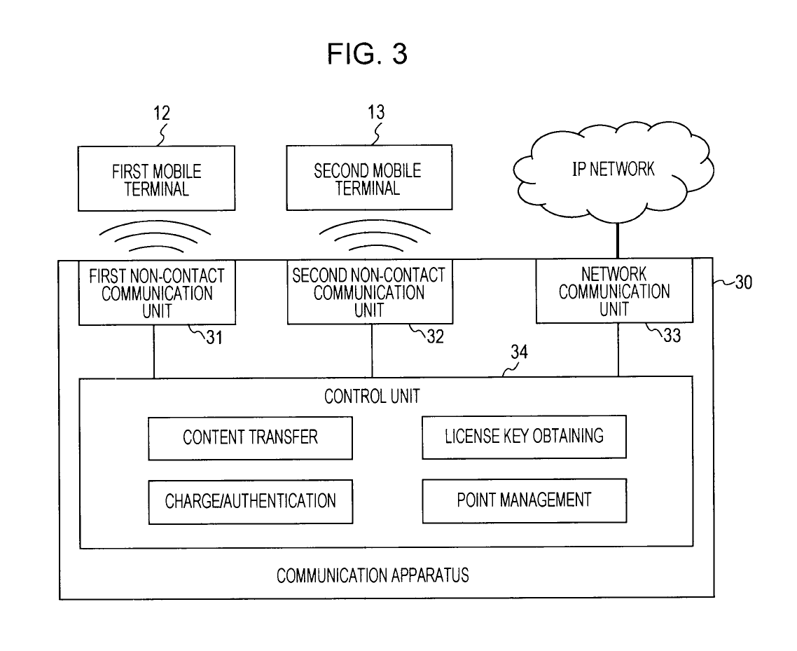

FIG. 3 schematically shows a configuration example of the communication apparatus 30 which can be operated as the kiosk terminal 11 in the communication system 10 shown in FIG. 1.

The communication apparatus 30 includes a first non-contact communication unit 31, a second non-contact communication unit 32, a network connection unit 33, and a control unit 34.

The first non-contact communication unit 31 and the second non-contact communication unit 32 can be independently operated without interfering with each other. Although it is not necessary that the first non-contact communication unit 31 and the second non-contact communication unit 32 are based on the same communication scheme, the first non-contact communication unit 31 is based on the same communication scheme as that for the non-communication unit of the first mobile terminal 12 (the transfer source of content) while the second non-contact communication unit 32 is based on the same communication scheme as that for the non-contact communication unit of the second mobile terminal 13 (the transfer destination of content).

The network connection unit 33 can connect to the public network such as the Internet based on a communication protocol such as TCP/IP or the like. The communication apparatus 30 can obtain a license key of content from the license management server 14 on the public network via the network connection unit 33.

The control unit 34 performs the overall control on the operations of the communication apparatus 30. In the embodiment, the control unit 34 realizes a content transfer function of relaying content transfer between the mobile terminals communicating by the first non-contact communication unit 31 and the second non-contact communication unit 32, a license key obtaining function of obtaining a license key of the content transferred between the mobile terminals from the license management server, a charging and authentication processing function of performing charging and authentication processing when the content and the license key are sent to the mobile terminal as the content transfer destination, and a point management function of refunding points or the like to the mobile terminal as the content transfer source in return to the provision of the content.

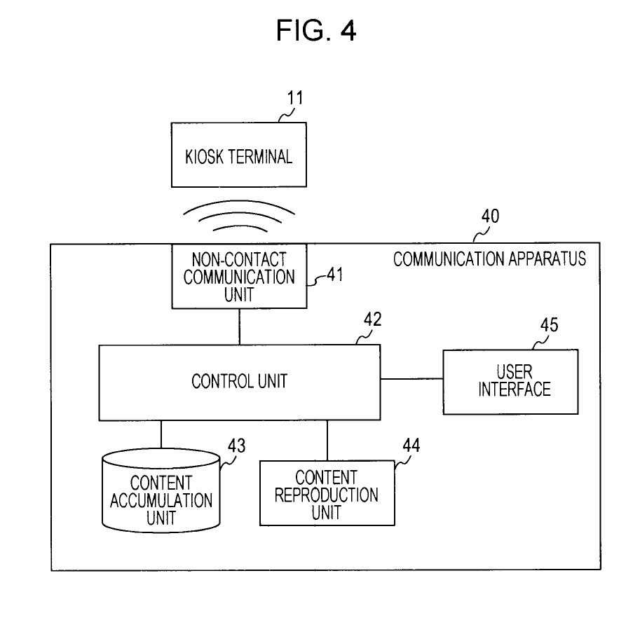

FIG. 4 schematically shows a configuration example of the communication apparatus 40 which can be operated as the mobile terminal 12 or 13 in the communication system 10 shown in FIG. 1.

The communication apparatus 40 includes a non-contact communication unit 41, a control unit 42, a content accumulation unit 43, a content reproduction unit 44, and a user interface 45.

The non-contact communication unit 41 establishes connection by non-contact communication when the communication apparatus 40 is held over the kiosk terminal, which makes it possible to communicate data such as a content file, a license key, and the like.

The content accumulation unit 43 accumulates content transfer from another mobile terminal via the kiosk terminal and content obtained by another tool. The content reproduction unit 44 reproduces the content accumulated in the content accumulation unit 43 with the use of the license key obtained from the kiosk terminal.

The user interface 45 is provided with a display screen which outputs the reproduction content and other screen data, an operation unit which receives a user's operations, and the like.

The control unit 42 performs overall control on the operations within the communication apparatus 40 such as the non-contact communication unit 41, the content accumulation unit 43, the content reproduction unit 44, the user interface 45, and the like.

The non-contact communication performed between the kiosk terminal and the mobile terminal is not limited to a specific communication scheme, and any one of an electrostatic coupling type, an electromagnetic induction type, a radio frequency communication type, and the like. It is possible to realize ultrahigh speed data transmission of about 100 Mbps in content transfer between the mobile terminals via the kiosk terminal if close proximity wireless transfer “TransferJet (registered trademark)” using a faint UWB signal is employed. The principle of the close proximity wireless transfer will be described.

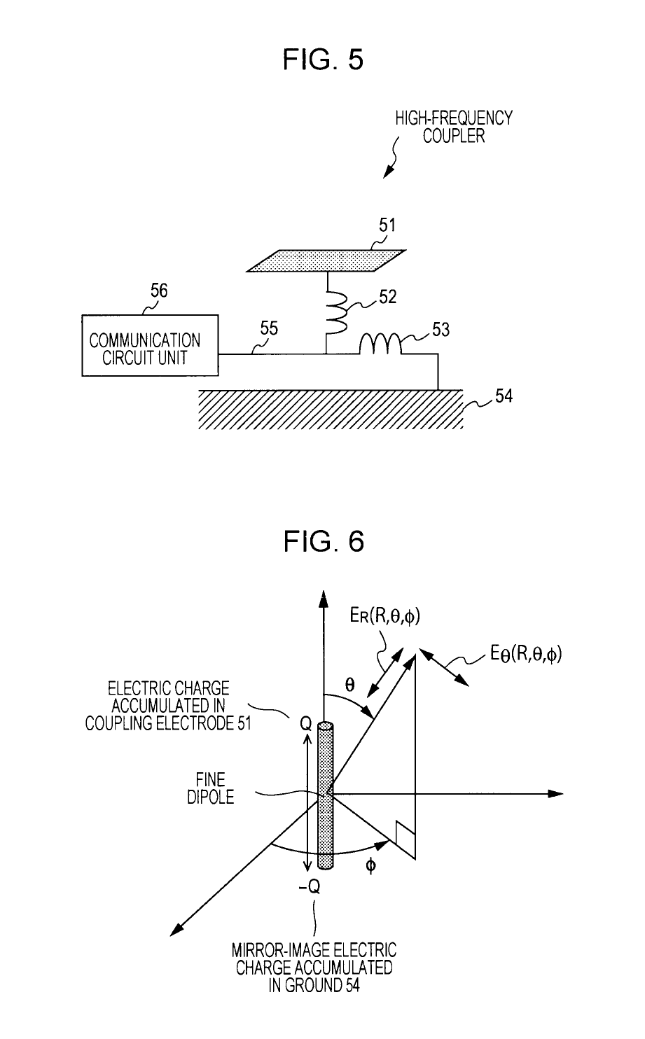

For the close proximity wired transfer, a high-frequency coupler as shown in FIG. 5 is used as an antenna element. The high-frequency coupler is provided with a planer coupling electrode 51 and a resonance unit including a serial inductor 52 and a parallel inductor 53 and connected to a communication circuit unit 56 via a high-frequency signal transmission path 55.

A high-frequency communication signal flows into the coupling electrode 51, and an electric charge is accumulated therein. At this time, the current flowing into the coupling electrode 51 via the transmission path is amplified by a resonance action of the resonance unit including the serial inductor 52 and the parallel inductor 53, and a larger electric charge is accumulated therein. If the electric charge is accumulated in the coupling electrode 51, a mirror-image electric charge is accumulated in the ground 54. If a point electric charge Q is positioned outside the planer conductor, a mirror-image electric charge −Q (which is a virtual electric charge obtained by replacing the surface electric charge distribution) is positioned within the planar conductor, which has been known in the related art as described in “Denjikigaku (Electromagnetism)” by Masashi Mizoguchi (Shokabo Publishing Co., Ltd, page 54 to 57).

As a result of the accumulation of the point electric charge Q and the mirror-image electric charge −Q as described above, a small dipole of a line segment connecting the center of the electric charge accumulated in the coupling electrode 51 to the center of the mirror-image electric charge accumulated in the ground 54 is formed. In a precise sense, the electric charge Q and the mirror-image electric charge −Q have volumes, and the small dipole is formed so as to connect the center of the electric charge and the mirror-image electric charge. The “small dipole” here means an “electric dipole whose distance between electric charges is very short”. For example, a “small dipole” was also described in “Antenna Denpa Denpan (Antenna/Radio-Wave Propagation) by Yasuto Mushiake (Corona Publishing Co., Ltd., page 16 to 18). Then, transverse wave component E_{θ} of the electric field, a longitudinal wave component E_{R} of the electric field, and a magnetic field H_{φ} around the small dipole are generated by the small dipole.

FIG. 6 shows the electric field by the small dipole. As shown in the drawing, the transverse wave component E_{θ} of the electric field is vibrated in a direction perpendicular to the propagation direction, and the longitudinal wave component E_{R} of the electric field is vibrated in a direction parallel to the propagation direction. In addition, a magnetic field His generated around the small dipole. The following formulae (1) to (3) represent the electromagnetic field generated by the small dipole. In the formulae, a component which is inversely proportional to the cube of the distance R is an electrostatic magnetic field, a component which is inversely proportional to the square of the distance R is an induction electromagnetic field, and a component which is inversely proportional to the distance R is a radiation electromagnetic field.

$$\begin{matrix}{E}_{θ} = \frac{p {e}^{- j kR}}{4 π ɛ} ( \frac{1}{{R}^{3}} + \frac{j k}{{R}^{2}} - \frac{{k}^{2}}{R} ) sin θ & ( 1 ) \\ {E}_{R} = \frac{p {e}^{- j kR}}{2 π ɛ} ( \frac{1}{{R}^{3}} + \frac{j k}{{R}^{2}} ) cos θ & ( 2 ) \\ {H}_{φ} = \frac{jω p {e}^{- j kR}}{4 π} ( \frac{1}{{R}^{2}} + \frac{j k}{R} ) sin θ & ( 3 )\end{matrix}$$

It is considered to be preferable that the longitudinal wave E_{R} without containing a radiation electric field component is used while the transverse wave E_{θ} containing a radiation electric field component is suppressed in order to suppress an interfering wave to the circumferential systems. This is because the longitudinal wave component E_{R} does not contain the radiation electric field while the transverse wave component E_{θ} of the electric field contains the radiation electric field which is inversely proportional to the distance (that is, whose distance attenuation is small) as can be understood from the above formulae (1) and (2).

It can be understood from the above formula (2) that the longitudinal wave component E_{R} is maximized when the angle θ with respect to the direction of the small dipole is 0°. Therefore, it is preferable to arrange the high-frequency coupler on the side of the communication counterpart such that the angle θ with respect to the small dipole is about 0° and transmit a high-frequency electric field signal in order to perform non-contact communication by efficiently using the longitudinal wave E_{R} of the electric field. In addition, it is possible to further increase the current of the high-frequency signal flowing into the coupling electrode 51 by the resonance unit including the serial inductor 52 and the parallel inductor 53. As a result, it is possible to increase the moment of the small dipole formed by the electric field accumulated in the coupling electrode 51 and the mirror-image electric charge on the side of the ground and effectively output the high-frequency electric field signal of the longitudinal wave E_{R} in the propagation direction whose angle θ with respect to the direction of the small dipole is about 0°.

Next, description will be made of the processing operations executed by the kiosk terminal 11 and each mobile terminal 12 or 13 in the communication system 10 shown in FIG. 1.

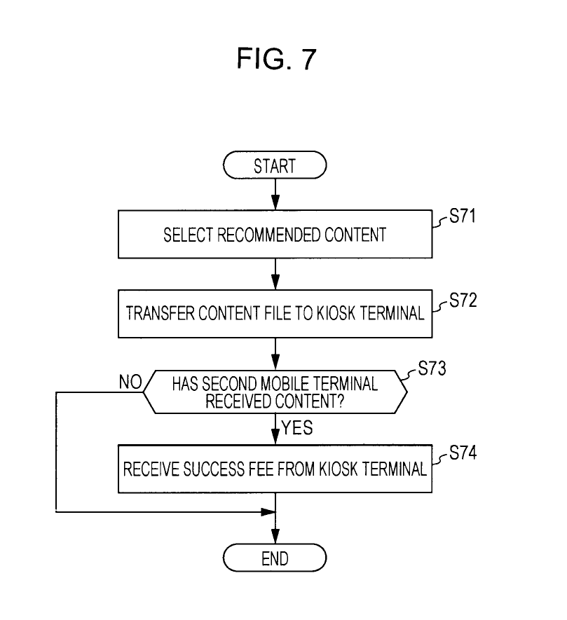

FIG. 7 shows a processing procedure executed by the first mobile terminal 12 in the communication system shown in FIG. 1 when the operation sequence shown in FIG. 2 is performed, in the form of a flowchart. The processing procedure in the drawing can be realized by executing a predetermined program code by the control unit 42 in the communication apparatus 40 which is operated as the first mobile terminal 12.

First, a user of the first mobile terminal 12 selects content to be recommended to his/her friend or acquaintance from among the purchased content items (content items accumulated in the content accumulation unit 43) via the user interface 45 (Step S71).

The first mobile terminal 12 transfers the content file selected by the user to the kiosk terminal 11 via the non-contact communication unit 41 (Step S72).

Here, it is assumed that the friend or acquaintance possesses the second mobile terminal 13 and holds this over the kiosk terminal 11. The user on the side of the second mobile terminal 13 may receive the transferred content file or reject the receiving thereof, that is, the purchasing thereof. When the receiving of the content file is rejected, this processing routine is completed as it is.

If the second mobile terminal 13 receives the content (Yes in Step S73), point refund or a commission charge corresponding to the completion bonus for the recommendation of the content is received (Step S74), and this processing routine is completed.

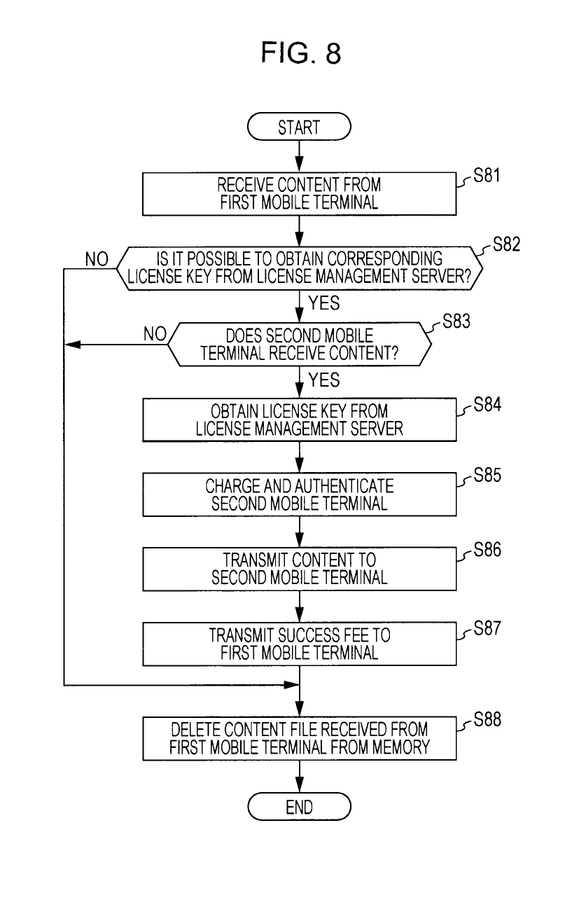

FIG. 8 shows a processing procedure executed by the kiosk terminal 11 in the communication system shown in FIG. 1 when the operation sequence shown in FIG. 2 is performed, in the form of a flowchart. The processing procedure in the drawing can be realized by executing a predetermined program code by the control unit 34 in the communication apparatus 30 which is operated as a kiosk terminal 11.

If a content file is received from the first mobile terminal 12 by the first non-contact communication unit 31 (Step S81), the kiosk terminal 11 temporarily stores this content file and checks whether or not it is possible to obtain a license key for this content from the license management server 14 (Step S82). If the corresponding license key is not available (No in Step S82), the content file which has been received from the first mobile terminal 12 and temporarily stored is deleted (Step S88), and this processing routine is completed.

If the license key can be obtained (Yes in Step S82), the kiosk terminal checks whether or not the second mobile terminal 13 will receive this content via the second on-contact communication unit 32 (Step S83). If the receiving of the content is rejected on the side of the second mobile terminal 13 (No in Step S83), the content file which has been received from the first mobile terminal 12 and temporarily stored is deleted (Step S88), and this processing routine is completed.

If the second mobile terminal 13 receives the content (Yes in Step S83), the kiosk terminal 11 connects to the license management server 14 via the network communication unit 33 and obtains a license key (Step S84), performs charging and authentication processing on the second mobile terminal 13 via the second non-contact communication unit 32 (Step S85), and sends the content file to the second mobile terminal 13 (Step S86).

In addition, the kiosk terminal 11 performs a points refund or a commission charge payment corresponding to the completion bonus for the recommendation of the content on the first mobile terminal 12 via the first non-contact communication unit 31 (Step S87).

Then, the kiosk terminal 11 deletes the content file, which is received from the first mobile terminal 12 and temporarily stored, from the memory (Step S88) and completes this processing routine.

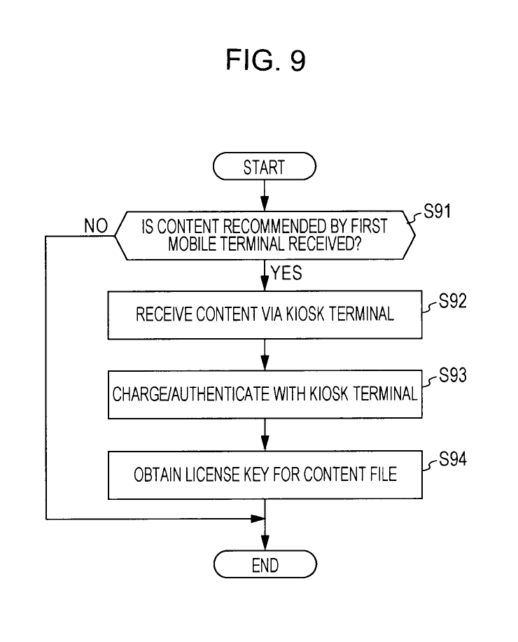

FIG. 9 shows a processing procedure executed by the second mobile terminal 13 in the communication system shown in FIG. 1 when the operation sequence shown in FIG. 2 is performed, in the form of a flowchart. The processing procedure in the drawing can be realized by executing a predetermined program code by the control unit 42 in the communication apparatus 40 which is operated as the second mobile terminal 13.

The user of the second mobile terminal 13 selects whether or not the recommended content is received, via the user interface 45 (Step S91). The selection result is delivered to the kiosk terminal 11 via the non-contact communication unit 31.

If the user selects the receiving of the content (Yes in Step S91), the second mobile terminal 13 receives the content file with the relay of the kiosk terminal 11 via the non-contact communication unit 31 (Step S92), and charging and authentication processing is performed with the kiosk terminal 11 (Step S93), obtains a license key for the received content file (Step S94), and completes this processing routine. Thereafter, the second mobile terminal 13 can reproduce the content with the use of the obtained license key. In addition, if the user rejects the receiving of the content (No in Step S91), this processing routine is completed as it is.

Although embodiments in which a kiosk terminal relays the exchange of fee-charged content between two mobile terminals was described above, the kiosk terminal can also relay the purchase of fee-charged content by the mobile terminal. In such a case, it is possible to receive the content provided by a content provision server on the network and purchase a license key from the license management server by the mobile terminal without connecting to the network.

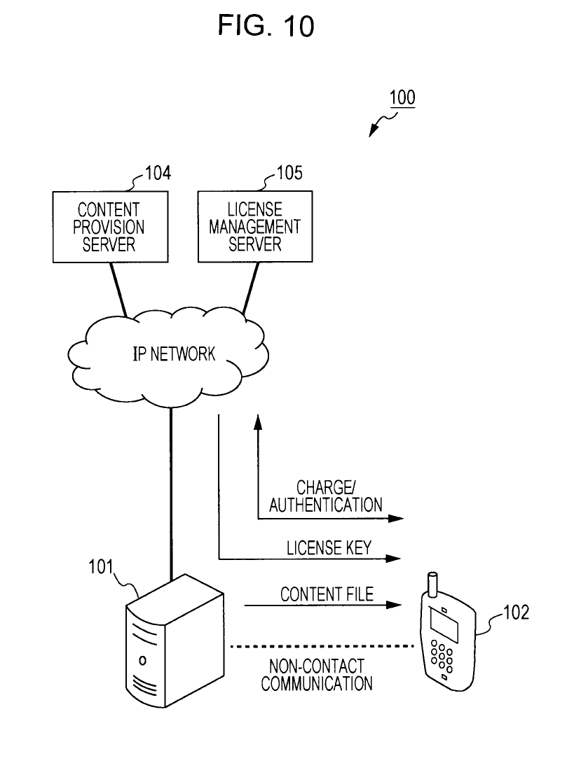

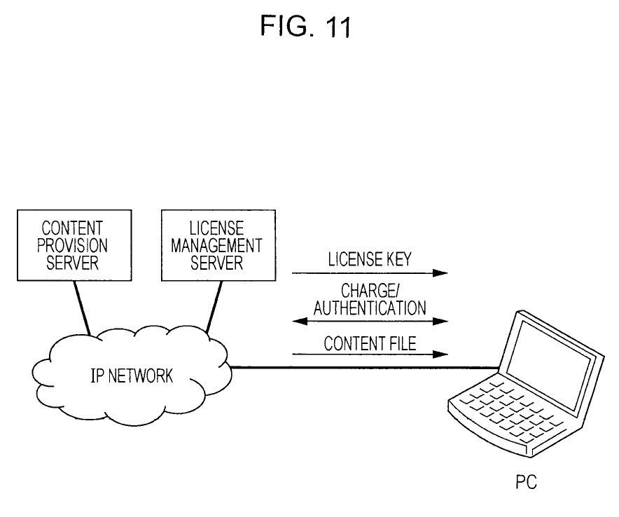

FIG. 10 schematically shows a configuration example of the communication system 100 by which fee-charged content is purchased by a mobile terminal with the relay of the kiosk terminal connected to the network.

The communication system 100 in the drawing includes a kiosk terminal 101 provided with a network connection unit and a non-contact communication unit and a mobile terminal 102, which is provided with a non-contact communication unit, by which content can be purchased. The non-contact communication units of the kiosk terminal 101 and the mobile terminal 102 are based on the same communication scheme. The kiosk terminal 101 and the mobile terminal 102 have the apparatus configurations shown in FIGS. 3 and 4, respectively.

First, the mobile terminal 102 is held over the kiosk terminal 101. The mobile terminal 102 is directly connected only to the kiosk terminal 101 via the non-contact communication unit while the kiosk terminal 101 is connected to the public network and can relay the exchange of data with the server on the network.

The user of the mobile terminal 102 selects content to be purchased via the user interface 45, and the selection result is then delivered to the kiosk terminal 101 via the non-contact communication. Alternatively, the user selects content to be purchased from among the content items displayed on a display of the kiosk terminal 101. The kiosk terminal 101 obtains the selected content file from the content provision server 104 via the network and then transfers the content file to the mobile terminal 102 by non-contact communication.

Subsequently, the kiosk terminal 101 relays the charge and authentication processing between the license management server 105 which provides the license key for the content and the mobile terminal 102.

After the charge and authentication processing, the mobile terminal 102 can obtain the license key for the content with the relay of the kiosk terminal 101. Thereafter, the mobile terminal 102 can reproduce the obtained content with the use of the license key.

The present disclosure contains subject matter related to that disclosed in Japanese Priority Patent Application JP 2010-204039 filed in the Japan Patent Office on Sep. 13, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A communication system comprising:
a first communication apparatus connected to a license management server which manages a license key for content via a network;
a second communication apparatus which performs a first non-contact communication with the first communication apparatus; and
a third communication apparatus which performs a second non-contact communication with the first communication apparatus,
wherein the first communication apparatus performs
receiving of content, whose copyright is managed, from the second communication apparatus by the first non-contact communication and transferring the content to the third communication apparatus by the second non-contact communication, and
obtaining a license key for the content from the license management server via the network and transferring the license key to the third communication apparatus by the second non-contact communication.

2. A communication apparatus comprising:
a first non-contact communication unit;
a second non-contact communication unit; and
a network communication unit,
wherein content, whose copyright is managed, is received from a second communication apparatus by the first non-contact communication unit and transferred to a third communication apparatus by the second non-contact communication unit, and
wherein a license key for the content is obtained from a license management server by the network communication unit and transferred to the third communication apparatus by the second non-contact communication unit.

3. The communication apparatus according to claim 2,
wherein the license key for the content is obtained from the license management server and transferred to the third communication apparatus by the second non-contact communication unit after charging and authentication processing is performed on the third communication apparatus by the second non-contact communication unit.

4. The communication apparatus according to claim 3,
wherein points are paid to the second communication apparatus by the first non-contact communication unit in response to the charge on the third communication apparatus.

5. The communication apparatus according to claim 2,
wherein at least one of the first and second non-contact communication units include
a communication circuit unit which performs processing on a high-frequency signal for transmitting data,
a transmission path of a high-frequency signal, which is connected to the communication circuit unit,
a ground,
a coupling electrode which is supported so as to be distant from the ground by a height with which a wavelength of the high-frequency signal is ignorable, and
a resonance unit which increases a current flowing into the coupling electrode via the transmission path, and
wherein a small dipole of a line segment connecting the center of the electric charge accumulated in the coupling electrode and the center of a mirror-image electric charge accumulated in the ground is formed, and the high-frequency signal is transmitted to a communication counterpart positioned in an opposing manner such that an angle θ with respect to the direction of the small dipole is about 0°.

6. A communication method of a communication apparatus including a first non-contact communication unit, a second non-contact communication unit, and a network communication unit, the method comprising:
receiving content, whose copyright is managed, from a second communication apparatus by the first non-contact communication unit;
transferring the content to a third communication apparatus by the second non-contact communication unit;
obtaining a license key for the content from a license management server by the network communication unit;
performing charging and authentication processing on the third communication apparatus by the second non-contact communication unit; and
transferring the license key to the third communication apparatus by the second non-contact communication unit.
